(19) United States
(12) Patent Application Publication
(10) Pub. No.: US 2009/0272076 A1
(43) Pub. Date: Nov. 5, 2009

(54) Adjusting equipment for a tool

(76) Inventor: Alexander Biechteler, Ottobeuren (DE)

Correspondence Address: JACOBSON HOLMAN PLLC, 400 SEVENTH STREET N.W., SUITE 600, WASHINGTON, DC, 20004, US

(21) Appl. No.: 12/385,875

(22) Filed: Apr. 22, 2009

(30) Foreign Application Priority Data
Apr. 22, 2008 (DE) 10 2008 020 234.7

(51) Int. Cl. B65B 51/14; F16J 15/02

(52) U.S. Cl. 53/329; 277/637

(57) ABSTRACT

The invention refers to an adjusting equipment for moving a tool. The adjusting equipment comprises a housing open on one side which can be completed by a carrier plate supported axially shifting. By means of this a pressurable space is defined. The carrier plate carries the tool. Between the carrier plate and the housing a seal for sealing the gap is provided.

### BACKGROUND OF THE INVENTION

The invention refers to an adjusting device for moving a tool, in particular for moving or operating a sealing tool in a sealing device.

In known sealing devices the tool top part comprises a preferably rectangular shaped carrier plate with what a sealing plate is connected releasable. Both plates can be moved in the direction of the sealing plane. For that purpose for example separate pneumatic cylinders or lifting systems are known.

Also the bottom part of the tool which holds the trough-shaped packings filled with the packing goods are moved for sealing purposes with a sealing film vertically in the sealing plane in order to form a support for the top part of the tool. If necessary, by means of that also an enclosed space is created which holds the packing, which is evacuated before sealing the sealing film to remove the air from the packing which could disturb conservation of the packed goods.

In order to be able to carry out the sealing process the tool top part is in connection with a drive which moves at least the carrier plate, together with the sealing plate, from an end position alternating in the sealing plane and back in the end position.

### SHORT ABSTRACT OF THE INVENTION

Relating to this state of the art it is an object of the invention to provide an arrangement which can be realised easier.

This problem is solved by an adjusting equipment as described in the beginning where it is suggested that the adjusting equipment comprises a housing open on one side, the housing can be completed by a carrier plate supported axially shifting, and the housing with the carrier plate defines a pressurable space and the carrier plate carries the tool and a seal for sealing the gap between the carrier plate and the housing is either arranged at the carrier plate or the housing.

According to the invention the arrangement of an adjusting equipment spaced from the carrier plate which is realised for example as pneumatic cylinder and needs accordingly more space for building is deleted. A direct drive is rather realised which, on the one hand, can be realised economically, but also, on the other hand, space-saving.

The invention furthermore suggests eventually also a smaller number of single components which can also be dismantled in a simple way which, in particular, makes cleaning of the entire adjusting equipment, for example the sealing tool, considerably easier and thus improves considerably the hygienic qualities of an accordingly fitted packaging machine or other accordingly fitted machines.

The design of the single components is rather simple and uncomplicated which also makes an economic production possible.

Basically the adjusting equipment can be designed in such a way that the entire housing corresponds with the tool top part, for example the sealing top part, and thus a rather large surface at the carrier plate is available. The result is here a quite large pressurable surface of the carrier plate, already a rather small pressure of a pressure source being enough for a sufficiently large power with homogenous pressure distribution during the use of the adjusting equipment. This is in particular an advantage when the invention is used in a sealing tool.

According to the invention it is suggested that the carrier plate is supported axially shifting. This means that the carrier plate is movable preferably along a space axis.

According to the invention it is possible that the tool is designed in one piece with the carrier plate. As for cleaning purposes anyway removing of the carrier plate is provided in order to be able to clean the interior of the housing completely it is provided according to the invention that with the same dismantling technique also the tool is changed.

Alternatively to that it is provided that the carrier plate has a suitable seat for the tool, that is for example a sort of quick-action or quick-fixing device, and thus allows changing the tool.

The invention is shown exemplary in connection with the movement of a tool, for example a sealing tool in a sealing device of a packaging machine in the following. However, the invention is in no way limited to that, the adjustment equipment according to the invention serves as drive with small lifting movement but large unfolding of power, in particular for employment on large surfaces in a wide field of applications, without limiting the invention here to a special case of application of a packaging machine. If therefore in the following the case of application of a packaging machine will be discussed, the present invention can in no way be limited to it, but it is to be understood as an example. It is also provided here that the carrier plate itself is employed as tool, for example, with suitable pressing tasks, that means the carrier plate does not necessarily have to carry a tool separately but is in different cases of application provided itself as a tool.

In a preferred modification of the invention it is provided that the seal is designed as butt seal which is the result of cutting yard ware into pieces. This suggestion according to the invention yields surprising results.

First of all it has been found that, although the butt seal suggested according to the invention actually has two abutting surfaces, a sufficiently sealing arrangement can be realised. The result of this is that the seal for the adjustment equipment according to the invention can be manufactured each time in the appropriate dimensions of the carrier plate and therefore can be adjusted very flexibly to the respective design of the adjustment equipment. The endless seals otherwise known in the state of the art, for example annular seals and so on, may be equipped without suitable abutting surfaces, but very inflexible as they only can seal one corresponding carrier plate shape or dimension. Furthermore by means of that only a sufficient supply of seals in yard ware is required a large part supply which otherwise would be necessary is avoided by this suggestion according to the invention, an arrangement of this type is therefore accordingly economic. The suggestion according to the invention combines a high flexibility of the use of the seal with low supply costs.

Instead of a seal designed as butt seal the invention also comprises a solution where an endless seal, for example an annular seal and so on, is used. This modification as well achieves, in particular in the adjusting equipment according to the invention, the advantages explained in the beginning. Therefore the invention comprises both modifications, the solution with a butt seal as well as the solution with an endless seal.

According to the invention it is provided that the seal is arranged either at the carrier plate (which will be also shown later on in the drawing) or in the housing, and serves for sealing the gap between carrier plate and housing. Of course, also the seal designed as butt seal can be employed, according to the invention, in both before-mentioned modifications accordingly.

It is an essential advantage of this modification according to the invention that by the suggestion each size of adjusting equipments or housings can be equipped with a working seal. The arrangement can be adjusted to the respective case without any problems.

In a preferred modification of the invention it is provided that at least the circumference/contour of the carrier plate and/or the circumference/contour of the tool and accordingly also the interior of the housing is preferably designed in the shape of a rectangle. By the suggestion according to the invention another design of the housing or the carrier plate or the tool is not excluded, the shape of the carrier plate or the tool follows of course in particular the packing which has to be produced or the case of application of the adjusting equipment according to the invention.

Cleverly in another alternative according to the invention it is provided that at least the corner areas of the carrier plate and of the interior of the housing have a sufficiently large radius. As the seal is manufactured by cutting yard ware into lengths it is, of course, provided that the seal can also follow suitable curves at the carrier plate or the housing. For that corresponding small radii are provided at the carrier plate, which do not stress the seal too much by bending. The sufficiently large, concrete radius is defined by the respective design of the seal.

The housing is, according to a design of the invention, equipped with an opening for a pressure means connection. As already explained rather small pressure differences are enough for a sufficient movement of the carrier plate. Usually gas, for example air, is provided as pressure medium, instead of this pneumatic system also a hydraulic system can be used in the same way according to the invention.

Besides the building-up of overpressure in the pressurable space which is limited by the housing and the carrier plate, it is, however, also possible to realise in this space underpressure, and thus to enable the carrier plate to retreat. Such a design provides a first means for resetting the carrier plate in the housing. However, additionally also other resetting means arranged between the carrier plate and the housing are provided, according to the invention, which effect a retreating movement of the carrier plate, in particular when the system is not pressurised.

Cleverly it is provided that the seal is arranged in a groove of the carrier plate or the housing. As already mentioned it is possible that the suggestion according to the invention can be realised in two modifications, namely in such a way that the seal is provided in the carrier plate or in the housing, the use of a groove for the seal allowing a rather simple but reliable mounting of the seal.

The arrangement of the seal in the moving carrier plate has to be preferred as by means of it the seal is designed moving together with it, and the carrier plate can therefore be designed rather narrow. The modification according to which the seal is arranged in the interior wall of the housing leads eventually to a stationary seal, and therefore may make a thicker carrier plate necessary, as this has to interact closely with the seal along the moving path. Therefore it is a sufficient criterion that the thickness of the carrier plate then has to be slightly larger than the planned moving path of the carrier plate in the adjusting equipment.

For the design of the seal it is provided that it has a seal foot and a seal head, the seal food being preferably put in the groove, in particular being attached clamping.

By dimensioning the groove suitably with regard to the seal, in particular the seal foot here a close interaction of the seal with the groove is achieved in particular when the seal has to be put slightly clamping in the groove. Furthermore the clamping inserting or holding of the seal foot in the groove has the advantage that during mounting the adjusting equipment according to the invention the seal does not fall out again and gets in the way. By means of that the mounting of the adjusting equipment is accordingly made easier. Furthermore it has to be taken into consideration that a sealing effect is expected from the seal in particular in interaction either with the interior wall of the housing or the carrier plate, that means there is a certain relative movement because of the adjusting movement of the carrier plate at the seal which may lead to a corresponding wear. The friction forces occurring here may lead to the seal being pulled out of the groove so that the clamping forces or the clamping effect is cleverly chosen in such a way that this situation does not occur.

In a preferred modification of the invention it is provided that the seal, seen in a sectional view, is essentially H-shaped. Between the seal head and the seal foot a constriction is provided which may be also very varied to this H-like design. The provided constriction leads to a corresponding flexibility of the single elements of the seals, in particular in the area of the seal head or the seal foot.

In a preferred modification of the invention it is provided that the seal head has at least one sealing lip. Often also several sealing lips are arranged one behind the other leading to a labyrinth seal and thus improve the sealing effect further.

The preferred material for the sealing is, for example, caoutchouc, rubber, cellular rubber or Silicon material, of course also suitable mixtures or other materials with corresponding shares of the before-mentioned materials are provided according to the invention.

In a preferred modification of the invention it is provided that the seal foot is wider than the seal head. This achieves that the seal head is hardly or not at all in contact with the groove in which the seal is put in, and thus also seal areas of the seal foot are pressurised with the pressure prevailing in the pressurised space, and thus also are pushed snugly in the groove, in particular in the groove bottom by this pressure. However, this is not the only effect. As by the arrangement of the constriction or the H-shape of the seal provided according to the invention there is also a certain flexibility in the seal head, here in particular in the area of the sealing lips, this pressure prevailing in the space acts also on this area and pushes it additionally to the wall interacting with the seal for example the interior wall of the housing, or, if the arrangement is employed vice versa, to the side area of the carrier plate.

The result of that is a very snugly design of the seal which becomes sealing just if pressurised accordingly.

Furthermore it is provided that the width of the seal is larger than its height. The height is the dimension of the seal which extends from the seal head to the seal foot. The width is orientated rectangular to it. A dimensioning of this type results in a preferred bending behaviour of the seal provided as yard ware, namely that the seal can be bent preferably around a bending axis orientated vertically to the connection line from the seal foot to the seal head.

In a preferred modification of the invention a symmetric construction of the seal is provided. Such a design makes the arrangement independent from the direction in which the seal has been put in the groove. The conditions each are the same.

Conveniently it is provided that the abutting surfaces provided at the end of the butt seal put in the groove are in contact. Alternatively, if necessary, also a seal linking part is provided between the two ends by means of which, for example, tolerances in the dimensions can be compensated.

By the contact of the two abutting surfaces, of course, automatically a suitable sealing at both ends of the butt seal is reached. Cleverly here the, arrangement is chosen such that the abutting surfaces are parallel.

Cleverly in a modification according to the invention the arrangement is chosen such that the abutting surfaces are arranged in an area of the groove extending straight. Exactly the end of the seal is prone to easily sliding out of the groove, which occurs preferably in the corner or curving area where anyway already corresponding elastic forces act on the seal because of the bending. Therefore the arrangement is chosen such that the seal is continuous in the curved area and the ends of the seal are in a straight area of the groove and the abutting surfaces are here in contact with each other.

The disadvantages described in the beginning refer in particular to a sealing device for sealing packings by means of a sealing film, the sealing device comprising a tool top part and a tool bottom part. The problem of the invention described in the beginning is solved in particular by such a sealing device where the tool top part or the tool bottom part comprises an adjusting equipment as described.

As a rule here a tool part interacts with another tool part as support. For example, the tool top part is designed moving, and the tool bottom part serves as support, for the movement in the tool top part then, for example, an adjusting equipment, as described is provided. The kinematic reversal is expressly also part of the invention.

It is, of course, clear here that a sealing device is only one case of application in a generally defined tool device, and the tool device comprises a tool top part and a tool bottom part as described before.

In a clever modification of this sealing tool according to the invention the arrangement is chosen here such that the tool top part or the tool bottom part forms the housing. The elements, because of the type of construction any way provided at the sealing tool, namely the chamber top part as well as the sealing plate are double-used by this suggestion according to the invention, and thus a very compact construction is reached, which accordingly saves material. The tool top part thus is the housing of the adjusting equipment as well as part of the entire tool device. Of course, it is, according to the invention, in an alternative also possible to use the tool bottom part as housing. In this case the tool bottom part holds the adjusting equipment.

In the application case of a sealing tool a sealing plate is put in the tool, the sealing plate may be heated, if necessary. The sealing plate is here attached to the carrier plate by suitable means which are not relevant here.

The use of the invention is here in no way limited to a sealing tool. The invention can also be employed in other tools which are used, for example, for producing a packing, which requires a relative movement or adjusting movement of a tool. It is not necessary either to heat the tool.

In particular it is provided in a modification according to the invention that the housing is U-shaped, and the sealing film is guided at the open ends of the housing, between the free ends of the limbs and the tool bottom part of the sealing tool.

In particular in a packing machine which is equipped with a sealing tool as described above, the advantages of the invention can be seen in an impressing way. Thus the employment according to the invention realises an economic drive or adjusting equipment which can realise with a small level of pressure a rather high level of power, which can be cleaned easily and is thus recognised as hygienically safe, and which can be adjusted with small costs to any dimension of the adjusting equipment.

An essential advantage is in particular the result of the special use of a butt seal with an abutting surface at each of its end surfaces which is manufactured by cutting yard ware into lengths, and is employed for sealing the gap between a carrier plate and a housing, in particular in an adjusting equipment as described. It is expressly pointed out here that the carrier plate and the housing can be used, for example, also for other purposes than the adjusting equipment described in this application.

At this point it is pointed out that all characteristics mentioned in connection with the use of the seal or the butt seal according to the invention in connection with the sealing tool, the adjusting equipment or the packing machine, are, of course, accordingly part of the use of a butt seal, which is also part of the invention, and are seen as also disclosed and are also comprised by the invention. This means that all these characteristics can also, if necessary, be used in the use claim and are part of this invention and disclosure.

### BRIEF DESCRIPTION OF THE DIFFERENT VIEWS OF THE DRAWINGS

In the drawing the invention is shown exemplary. The embodiment shown here does not restrict the invention in any way to it. In the figures:

FIG. 1 in a sectional view the use of the adjusting equipment according to the invention, for example in a sealing device, if necessary, also according to the invention;

FIG. 2a an enlargement of the detail of the dash-dotted circle according to FIG. 1;

FIG. 2b in a detailed view the seal according to the invention and

FIG. 3 in a top view the carrier plate with seal put in, according to the invention.

### DETAILED DESCRIPTION OF THE PREFERRED EMBODIMENT

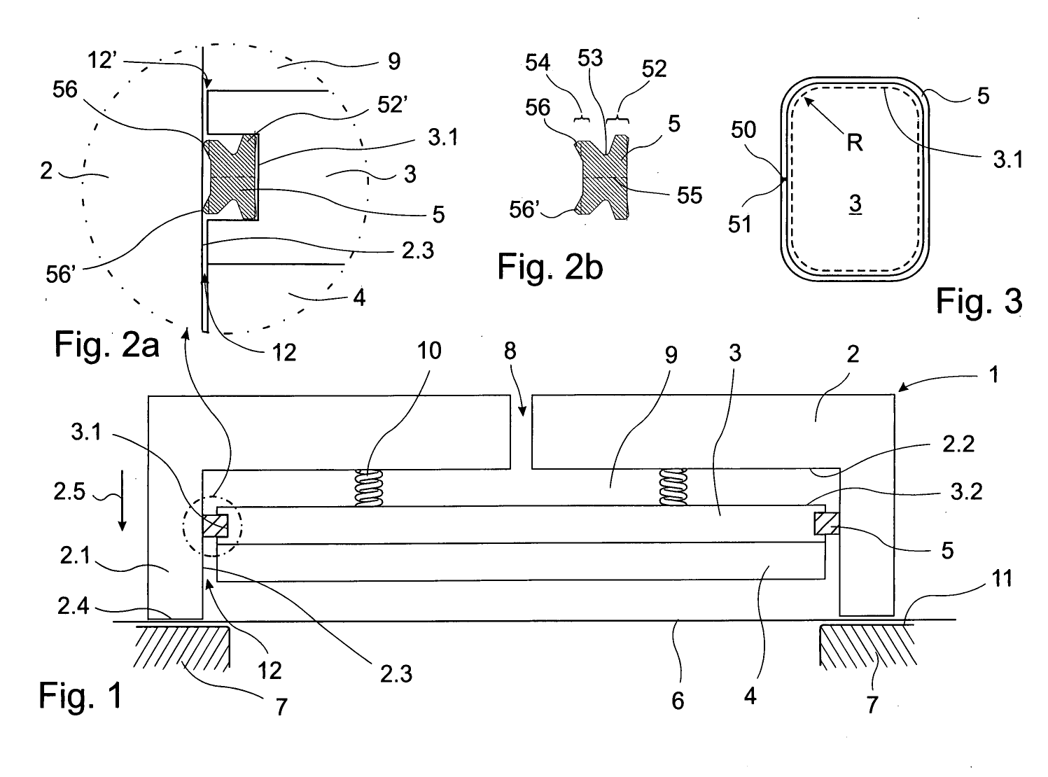

In FIG. 1 the employment of an adjusting equipment according to the invention in a tool top part 1 is shown schematically. As tool top part 1 is seen here, for example, a sealing tool for sealing an upper film to a lower film equipped with troughs. The upper film or sealing film 6 is indicated in the drawing, the lower film is not shown.

The tool top part 1 consists essentially of a housing 2 designed like an upturned pot. It has a bottom 2.2 where, as shown in the section, the limbs 2.1 extend U-like downward. At the bottom edge 2.4 of the limbs the sealing film 6 is guided along. It will be fastened by clamping during a short time between this part of the tool top part 1 and the tool bottom part 7 in the sealing plane 11 when these two parts have been approached to each other for sealing, as it is indicated by arrow 2.5 for the tool top part 1.

In the housing 2 the carrier plate 3 is supported moving, axially shifting. The movement of the carrier plate 3 rectangular to its orientation or extension is done by corresponding overpressure in the pressurable space 9 which is, on the one hand, limited by the bottom 2.2 of the housing 2 as well as the interior wall 2.3, which is linked rectangular, as well as the interior side 3.2 of the carrier plate 3. In the bottom 2.2 of the housing 2 an opening 8 is provided through which a suitable pressure means or even vacuum can be impressed in the space 9. By the application of vacuum also a retreating movement of the carrier plate upward in the example shown here can be realised. The building-up of overpressure in the space 9 results in a movement of the carrier plate 3 downward.

Furthermore for the resetting movement (for example alternatively) resetting means 10 are provided; these are designed, for example, as tension springs and act against the power occurring by building-up pressure in the interior space 9. As resetting means, besides the employment of springs, which are arranged here in pairs or in larger numbers, also a vacuum or other means can be employed.

Between the carrier plate 3 and the limb 2.1 of the housing 2 there is a gap 12. In order to close this gap 12 as effectively and economically as possible, that means sealing it, according to the invention the use of a seal 5 is provided which is put partly in a groove 3.1, and projects at least slightly with its seal head 54 beyond it.

In the embodiment shown here the U-shaped groove 3.1 is provided in the carrier plate 3. The groove is provided at the circumference/contour of the carrier plate completely revolving in order to provide the complete edge area with a sealing. It is also possible to provide a groove with undercuts and so on, for example to result in a good seat with the seal by positive locking.

However, the invention is not restricted to it, it is in the same way also possible according to the invention to arrange a seal 5 in the lateral interior wall 2.3.

As it can be seen in FIG. 1 by means of the elements present anyway at a seal tool top part 1, carrier plate 3 carrying the sealing plate or a tool 4 with a very small additional effort a very effective improvement is achieved as, without using additional space for driving means in the space, which results anyway, above the carrier plate 3 this is used simply as pressurable space 9. The arrangement of the seal 5 in the groove 3.1 is chosen here such that the seal 5 is realised as butt seal manufactured by cutting seal yard ware, which can be produced as mass-produced article, into lengths and making it exactly to the dimension.

This is shown, for example, schematically in FIG. 3. Here the carrier plate 3 is shown from above, and the groove 3.1, in particular its bottom, is indicated in a dashed line. The seal 5 projects beyond the groove. In the left-hand area in the straight section the two abutting surfaces 50 and 51 are provided at the ends of the butt seal 5′. They are in contact with each other in order to cover the gap forming between them reliably.

It is an advantage of the invention that the seal designed in this way or the butt seal 5 can be adjusted to any shape and also dimension of the carrier plate 3 or also of the tool or the sealing plate 4. As the seal 5, in the form of yard ware, is mechanically stressed by bending it is striven for not to fall short of certain minimum radii in order to avoid an extreme stress of the seal 5.

Also in the design of the seal 5 some clever arrangements are provided which are explained in particular by means of FIGS. 2a and 2b. The basic construction of the seal 5 can be seen in particular in FIG. 2b. Seen in a sectional view the seal 5 is formed essentially H-like. In the right-hand area the seal foot 52, in the left hand area the seal head 54 is provided which are separated from each other by a constriction 53 on both sides. The construction of the seal 5 is essentially symmetric to a center plane 55 which corresponds in the seal shape abstracted as H the center web.

The seal foot 52 is the region which is put or pushed in the groove 3.1, cleverly the width of the groove being slightly smaller than the width of the seal foot 52 so that a certain clamping occurs and thus a good seat of the seal 5 in the groove 3.1.

The two sides of the symbolic H-like seal 5 do not have the same length. This means that the width of the seal foot 52 is larger than the width of the seal head 54 so that, as it can be seen clearly in FIG. 2a, a passage forms between the front end of the seal head and the massive area of the carrier plate 3, which is eventually connected with the pressurable space 9. If now pressure builds-up in the space 9 this pressure gets also above the remaining small gap 12′. The small gap 12′ extends here coming from space 9 between the carrier plate 3 and the housing 2 downward in the groove 3.1. The pressure prevailing in space 9 acts via this gap 12′ to the seal foot 52′ as well as to the upper sealing lip 56.

The depth of the groove 3.1 is here dimensioned such that it is slightly smaller than the height of the seal 5 so that the sealing lips 56, 56′ provided at the seal head 54 project slightly beyond it, and cover and close the occurring gap 12 reliably.

The upper part of the groove 3.1 is therefore in communicating interaction with the pressurable space 9; by the constriction 53 the foot area 52, 52′ as well as the sealing lips 56, 56′ provided in the seal head are slightly flexible toward each other and try to avoid the pressure accordingly. By means of that the seal foot 52′ is pushed even farther in the groove bottom 3.1, and in particular gaps or passages, which may occur, are closed safely.

The same goes also for the upper seal lip 56 which is safely pressed by the building pressure to the interior sidewall 2.3 of the housing 2.

Furthermore the seal foot 52 is formed such that it has a certain elasticity, and is also able to compensate so that the lower area does not necessarily have to be designed straight but curved and thus has a certain resilience potential.

The sealing lips 56, 56′ are designed essentially triangularly projecting at the seal head 54. The result is thus eventually a seal edge at the front end of the sealing lip 56. A double arrangement of the sealing lips, according to the invention even more than only two sealing lips can be employed, form a sort of labyrinth seal and improve the sealing effect.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Adjusting equipment for moving a tool, in particular for moving and operating, respectively, a sealing tool in a sealing device, the adjusting equipment comprising a housing (2) open on one side, the housing (2) being completed by a carrier plate (3) supported axially shifting, and the housing (2) defining with the carrier plate (3) a space (9) which can be pressurised, and the carrier plate (3) carrying the tool (4), and either at the carrier plate (3) or the housing (2) a seal (5) being arranged for sealing the gap (12) between carrier plate (3) and housing.

2. Adjusting equipment according to claim 1, characterised in that the seal (5) is designed as butt seal generated by cutting seal yard ware into lengths.

3. Adjusting equipment according to claim 1, characterised in that at least the circumference/contour of the carrier plate (3) and/or the circumference/contour of the tool (4) and accordingly the interior of the housing (2) form preferably the shape of a rectangle, and/or at least the corner areas of the carrier plate (3) and the ones of the interior of the housing have a sufficiently large radius (R).

4. Adjusting equipment according to claim 1, characterised in that the housing (2) has at least one opening (8) for connecting a pressure means, and/or between the carrier plate (3) and the housing (2) at least one means (10) resetting the carrier plate (3) is provided.

5. Adjusting equipment according to claim 1, characterised in that the seal (5) is arranged in a groove (3.1) of the carrier plate (3) or the housing (2).

6. Adjusting equipment according to claim 1, characterised in that the seal (5) has a seal foot (52) and a seal head (54), and the seal foot (52) can be put in the groove (3.1.) in particular clamping, and/or the seal (5) is, seen in a sectional section, designed essentially H-shaped.

7. Adjusting equipment according to claim 1, characterised in that the seal (5) has a seal foot (52) and a seal head (54), and the seal head (54) has at least one sealing lip (56, 56′).

8. Adjusting equipment according to claim 1, characterised in that the seal (5) consists of caoutchouc, rubber, cellular rubber or Silicon material.

9. Adjusting equipment according to claim 1, characterised in that the seal (5) has a seal foot (52) and a seal head (54), and the seal foot (52) is wider than the seal head (54).

10. Adjusting equipment according to claim 1, characterised in that the width of the seal (5) is larger than its height, and/or the seal (5) is characterised by a symmetric construction.

11. Adjustment equipment according to claim 1, characterised in that the seal (5) is designed as butt seal, and the abutting surfaces (50, 51) provided at the end of the butt seal (5) put in the groove (3.1) are in contact with each other, and/or the abutting surfaces (50, 51) are parallel to each other.

12. Adjusting equipment according to claim 1, characterised in that the seal (5) is designed as butt seal, and the abutting surfaces (50, 51) provided at the end of the butt seal (5) put in the groove (3.1) are in contact with each other, and the abutting surfaces (50, 51) are arranged in the groove area (3.1) extending straight.

13. Tool device, in particular sealing device for sealing packings by means of a sealing film, the tool device comprising a tool top part and a tool bottom part (1, 7), characterised in that the tool top part (1) or the tool bottom part (7) comprise an adjusting equipment for moving a tool, in particular for moving or operating a sealing tool in a sealing device, the adjusting equipment comprising a housing (2) open on one side, the housing (2) being completed by a carrier plate (3) supported axially shifting, and the housing (2) with the carrier plate (3) defining a pressurable space (9), and the carrier plate (3) carrying the tool (4), and either at the carrier plate (3) or the housing (2) a seal (5) being provided for sealing the gap (12) between carrier plate (3) and housing.

14. Tool device according to claim 13, characterised in that the tool top part and the tool bottom part respectively form the housing (2).

15. Tool device according to claim 13, characterised in that the tool (4) is formed by a sealing plate.

16. Tool device according to claim 13, characterised in that the tool top part and the tool bottom part respectively form the housing (2), and the housing (2) is shaped like a U, at the open end of the housing (2) between the free ends (2.4) of the limbs (2.1) and the tool bottom part (7) of the sealing tool the sealing film (6) being guided.

17. Packaging machine with a tool device, in particular sealing device for sealing packings by means of a sealing film, the tool device comprising a tool top part and a bottom part (1, 7), characterised in that the tool top part (1) or the tool bottom part (7) has an adjusting equipment for moving a tool, in particular for moving or operating a sealing tool in a sealing device, the adjustment equipment comprising a housing (2) open on one side, the housing (2) being completed by a carrier plate (3) supported axially shifting, and the housing (2) with the carrier plate (3) defining a pressurable space (9), and the carrier plate (3) carrying the tool (4), and either at the carrier plate (3) or at the housing (2) a seal (5) for sealing the gap (12) between the carrier plate (3) and the housing being arranged.

18. Use of a butt seal providing at each of its end surfaces an abutting surface, generated by cutting yard ware into lengths, for sealing the gap between a carrier plate and a housing, in particular in an adjusting equipment for moving a tool, in particular for moving or operating a sealing tool in a sealing device, the adjusting device comprising a housing (2) open on one end, the housing (2) being completed by a carrier plate (3) supported axially shifting, and the housing (2) with the carrier plate (3) defining a pressurable space (9), and the carrier plate (3) carrying a tool (4), and either at the carrier plate (3) or the housing (2) a seal (5) for sealing the gap (12) between the carrier plate (3) and the housing being arranged.
